(19) United States
(12) Patent Application Publication
(10) Pub. No.: US 2014/0208301 A1
(43) Pub. Date: Jul. 24, 2014

(54) FUNCTION CALLING COMPUTER PROGRAMS

(71) Applicant: International Business Machines Corporation, Armonk, NY (US)

(72) Inventors: Xiao Feng Guan, Shanghai (CN); Jiu Fu Guo, Shanghai (CN); Jian Jiang, Shanghai (CN); Hong Wei Zhu, Shanghai (CN)

(73) Assignee: International Business Machines Corporation, Armonk, NY (US)

(21) Appl. No.: 14/086,433

(22) Filed: Nov. 21, 2013

(30) Foreign Application Priority Data
Nov. 29, 2012 (CN) 201210500365.1

(51) Int. Cl. G06F 9/45

(52) U.S. Cl. CPC G06F 8/41
USPC 717/140

(57) ABSTRACT

The present invention discloses a method and apparatus for function calling that eliminates or reduces errors caused by calling convention mismatch by preparing a number of candidate code modules during program compiling and inserting them in a compiled program. A library of compiled candidate code modules is thus included in the complied program, which allows the user to call a function by specifying a function to be called and a library where it belongs in the source program, without need to know the calling convention thereof or to focus on the call execution process. This ensures the matching of calling convention between the caller and callee of the function while being transparent to users, so as to avoid problems caused by calling convention inconsistency.

### PRIORITY

This application claims priority to Chinese Patent Application No. 201210500365.1, filed Nov. 29, 2012, and all the benefits accruing therefrom under 35 U.S.C. §119, the contents of which in its entirety are herein incorporated by reference.

### BACKGROUND

The present invention relates to function calling in computer programs, and more specifically, to a method and apparatus for function calling that may be incorporated into compiled computer programs generally.

Different calling conventions are applied to different languages and required according to different needs. In general, passing parameters via registers could benefit run-time performance of program. However, passing too many parameters by registers will also impact execution performance since the compiler cannot make full use of all hardware registers in a single function. As a result, programs may choose different calling conventions for different functions to obtain optimal performance for applications. For example, different function libraries may use different calling conventions. In addition, different compilers have their own preferences on different calling conventions. For example, some compilers tend to pass complex parameters via general purpose registers, and some compilers tend to pass them via floating point registers.

A variety of different calling conventions can cause certain troubles to users. If the caller and the callee use different calling conventions for a function call, serious runtime errors might be caused. To avoid such errors, one possible solution requires the user to define the calling convention of exported function, which means the user must obtain corresponding header files, source code, and so on. As a result, this solution can become very burdensome for the user. The difficulties become worse whenever the files mentioned above are not readily available to the user. Another possible solution is to ask all function library providers to use the same “standard” calling convention. This method is not a viable solution, however, due to adverse effects on execution performance. Therefore, there is a need for a better function calling conventions to eliminate or reduce errors caused by calling convention mismatch.

### SUMMARY

The needs described above are realized in a method and apparatus for function calling that eliminates or reduces errors caused by calling convention mismatch by preparing a number of candidate code modules during program compiling and inserting them in a compiled program. A library of compiled candidate code modules is thus included in the complied program, which allows the user to call a function by specifying a function to be called and a library where it belongs in the source program, without need to know the calling convention thereof or to focus on the call execution process. This ensures the matching of calling convention between the caller and callee of the function while being transparent to users, so as to avoid problems caused by calling convention inconsistency.

According to one embodiment, a method for function calling includes, in response to detection of a function call in a program, obtaining a number of candidate code modules for executing the function call. The candidate code modules comply with a number of calling conventions, respectively. A specific calling convention used by a called function is obtained and, according to the specific calling convention obtained, a code module which complies with the specific calling convention is selected from the candidate code sections to execute the function call.

According to another embodiment, an apparatus for function calling includes a code module obtaining unit configured to, in response to detection of a function call in a program, obtain a plurality of candidate code modules for executing the function call, the plurality of candidate code modules complying with a plurality of calling conventions respectively. The apparatus also includes a calling convention obtaining unit configured to obtain a specific calling convention used by a called function; a code module selection unit configured to, according to the specific calling convention obtained, select from the plurality of candidate code sections a code module which complies with the specific calling convention to execute the function call.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 shows a block diagram of an exemplary computer system/server configured to implement embodiments of the present invention;

FIG. 2 shows a flowchart of a method for function calling according to an embodiment of the present invention;

FIG. 3 shows sub-procedures of determining a specific calling convention according to an embodiment;

FIGS. 4A-4B shows a code example according to an embodiment; and

FIG. 5 shows a block diagram of an apparatus according to the embodiment of the present invention.

### DETAILED DESCRIPTION

Embodiments may be realized in a computer system configured to call functions that includes preparing a number of candidate code modules during program compiling and inserting them in a compiled program. A library of compiled candidate code modules is thus included in the complied program, which allows functions to be called by specifying the desired function and library without utilizing the calling conventions of the specific module being called. As a result, the program designer or user only needs to specify a function to be called and a library where it belongs in the source program, without need to know the calling convention thereof or to focus on the call execution process. In the program compiling stage, while the source program is compiled, call execution codes of a number of versions, namely, a number of candidate code modules, are inserted into the compiled program, which are used to execute the calling process according to different calling conventions. The function and form of the candidate code modules are similar to “stub code” that may be inserted in a program to execute a specific function.

Most high level programming languages provide function calling. In the process of function calling, both the caller and the callee need to comply with a predetermined calling convention. Specifically, a calling convention refers to a protocol between the caller and callee of function call in a programming language. This protocol specifies certain operation manners in the calling process, including: where (registers or stack) to pass parameters, whether it is variadic parameters, which entity (caller or callee) is responsible for cleaning up stacks, etc. Different languages and different compilers define different calling conventions. For example, VC++ 6.0 defines the following calling conventions.

_cdec1 is a calling convention used by C/C++ and MFC programs by default, and may also be specified manually by adding_cdec1 keyword in the function declaration. With the _cdec1 convention, function parameters are pushed into the stack in an order from right to left, and it is the function caller's responsibility to pop up the parameters and thus cleans up the stack. Therefore, functions with alterable parameters must use this calling convention.

_stdcall calling convention is used to call Win32 API functions. With the _stdcal convention, function parameters are pushed into the stack in an order from right to left, and the function callee, before returning the parameters, cleans up the stack for parameters passing. Under this calling convention, the number of function parameters is fixed.

_fastcall calling convention is used for occasions with very high performance requirements. The _fastcall calling convention places two parameters, the size of which is not greater than 4 bytes (DWORD), starting from the left of the function, into ECX and EDX registers, respectively, the rest of the parameters are still transferred from right to left. It is the callee who cleans up the stack before function return.

In other programming languages, different calling conventions are defined correspondingly. For example, PASCAL defines a Pascal function calling specifically, but may also be used in C/C++. According to such calling convention, parameters are pushed onto the stack from left to right, opposite to _cdec1 and _stdcall. However, the way to clean up the stack is the same as in _stdcall.

Those skilled in the field of computer programming will appreciate that a variety of different calling conventions can cause certain troubles to users. If the caller and the callee use different calling conventions for a function call, for example, serious runtime errors might be caused. Embodiments of the present invention solve this problem by preparing a number of candidate code modules during program compiling and inserting them in a compiled program. This allows the user to call a function by specifying a function to be called and a library where it belongs in the source program, without need to know the calling convention thereof or to focus on the call execution process.

Certain embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter solution, the remote computer may be connected to the user's computer via any type of network, including a local area network (LAN) or a wide area network (WAN), or the connection may be made to an external computer (for example, via the Internet using an Internet Service Provider).

Aspects of the present invention are described below with reference to flowchart illustrations and/or block diagrams of methods, apparatus (systems) and computer program products according to embodiments of the invention. It will be appreciated that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational procedures to be performed on the computer, other programmable apparatus or other devices to produce a computer implemented process such that the instructions which execute on the computer or other programmable apparatus provide processes for implementing the functions/acts specified in the flowchart and/or block diagram block or blocks.

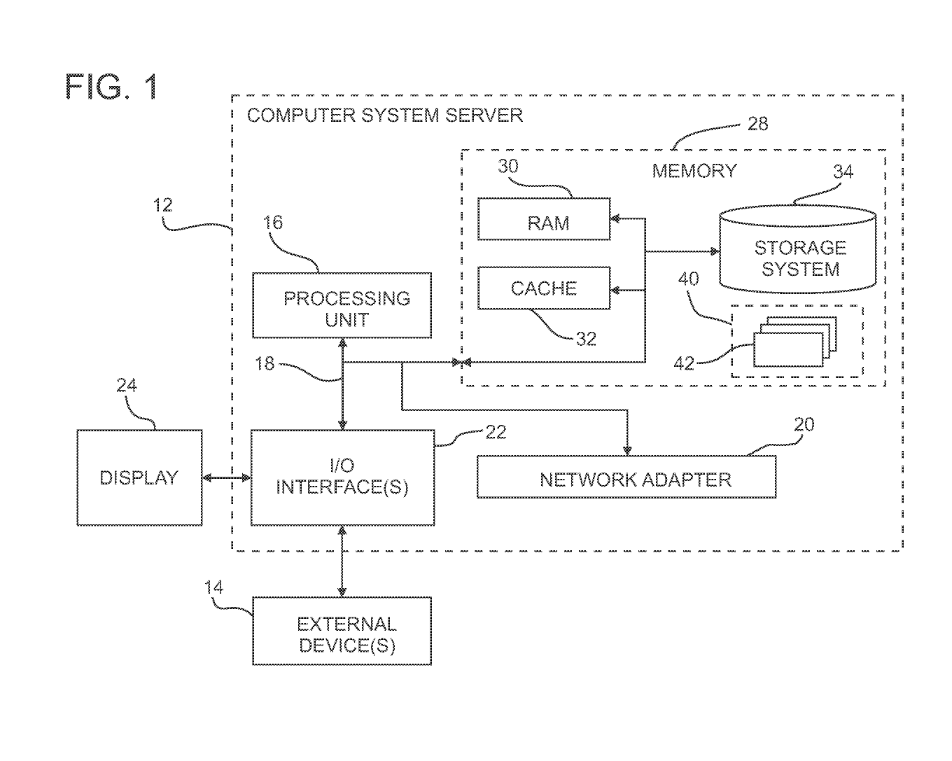

Referring now to FIG. 1, in which an exemplary computer system/server 12 which is applicable to implement the embodiments of the present invention is shown. Computer system/server 12 is only illustrative and is not intended to suggest any limitation as to the scope of use or functionality of embodiments of the invention described herein.

As shown in FIG. 1, computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be appreciated that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The embodiments of the present invention will be described below in conjunction with accompanying drawings and specific examples. According to the embodiments of the present invention, in the program compiling stage, a number of candidate code modules which comply with a number of different calling conventions, respectively, are provided for a function call in the program. In addition, according to additional code provided during compiling, the program in runtime can determine a specific calling convention used by the called function, and accordingly select one of the candidate code modules provided to execute the function call. Thus, match of calling convention between the caller and the callee is ensured, thereby avoiding problems caused by calling convention inconsistency.

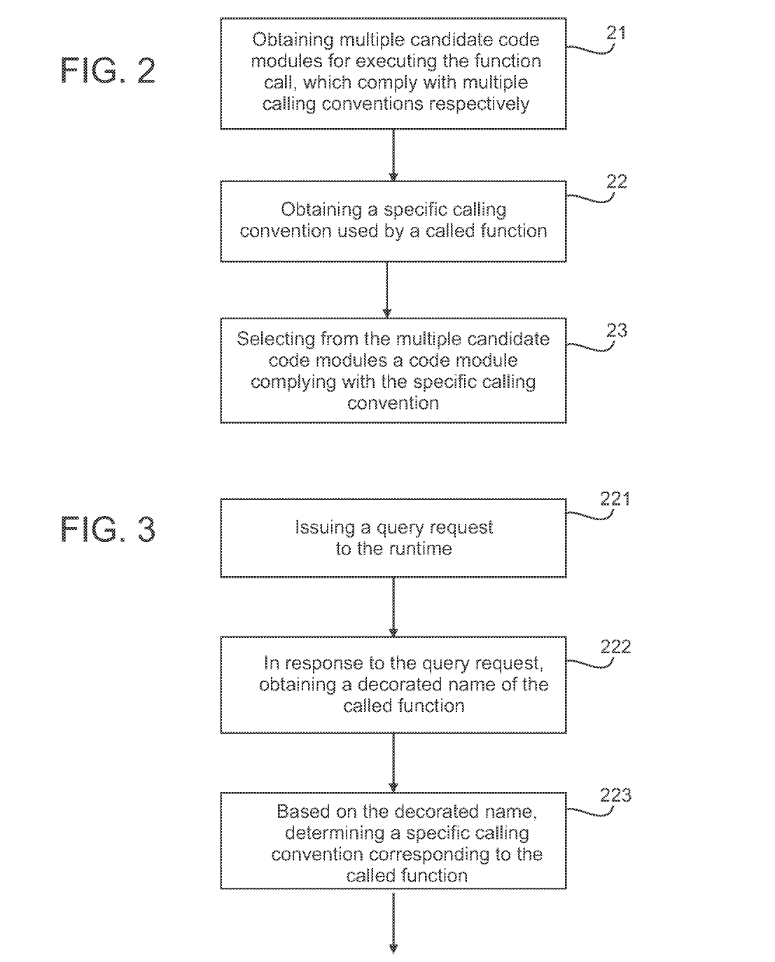

Referring now to FIG. 2, which shows a flowchart of a method for function calling according to an embodiment of the present invention. As shown in FIG. 2, the method includes: block 21 of, in response to detection of a function call in a program, obtaining a number of candidate code modules for executing the function call, the code modules complying with a number of calling conventions respectively; block 22 of obtaining a specific calling convention used by a called function; block 23 of, according to the specific calling convention obtained, selecting from the candidate code sections a code module which complies with the specific calling convention to execute the function call. The execution of the blocks is described below in combination with specific examples.

In one embodiment, first, in block 21, in response to detection of a function call in a program, a number of candidate code modules which comply with a number of calling conventions respectively are obtained for executing the function call. It may be understood that in the prior art, there has been a variety of ways to detect a function call in a program, e.g., to detect a key word used by a function call, to detect a format used by a function call, and so on. Different programming languages may use different keywords or formats to guide or indicate the calling of a function. For different programming languages, those skilled in the art can use different ways and standards correspondingly to detect function calls.

In response to detection of a function call, in block 21, a number of candidate code modules are obtained for the function call, candidate code modules complying with a number of calling conventions respectively and each for executing the function call. It may be understood that, when a function in an internal function library provided by the same one programming language is called, there is generally no calling convention mismatch problem. Thus, in one embodiment, in the case of detecting a function call in the program, the method further determines whether the function is from the internal function library. Only in the case where the called function is a function from an external function library, the above-mentioned candidate code modules are obtained.

In one embodiment, obtaining a number of candidate code modules includes preparing a number of candidate code modules during program compiling, and inserting them in a compiled program. That is, the program designer or user only needs to specify a function to be called and a library where it belongs in the source program, without need to know the calling convention thereof or to focus on the call execution process thereof. According to the method of the embodiment of the present invention, in the program compiling stage, while the source program is compiled, call execution codes of a number of versions, namely, a number of candidate code modules, are inserted into the compiled program, which candidate code modules are used to execute the calling process according to different calling conventions respectively. The function and form of the candidate code modules are similar to “stub code” in the prior art inserted in a program to execute a specific function.

For example, in a specific example, function FncA is called in a C program. To this end, three candidate code modules may be prepared, respectively, when the C program is compiled, to perform the call process according to possible calling conventions _cdec1, _stdcall and _fastcall in the C program respectively.

In one embodiment, at least one of the plurality of candidate code modules includes a prologue, a main body and an epilogue. The prologue is used to perform the preparatory work before the function calling, for example, to prepare parameters, to place parameters into stacks or registers, etc. The main body is used to execute the function call. The epilogue is used to do clean up after the function call. According to the different calling conventions used, the prologue and epilogue included in each candidate code module are different either. The execution of the various parts for different calling conventions is described below still by way of example of the aforementioned C program.

As mentioned above, in the case of the C program, three candidate code modules are obtained for _cdec1, _stdcall and _fastcall. The prologue in the candidate code module for _cdec1, or called the prologue for _cdec1, pushes prepared parameters into the stack in an order from right to left according to the calling convention of _cdec1, and the epilogue for _cdec1 pops parameters out of the stack to clean up the stack after the function call is finished. The prologue for _stdcal similarly pushes function parameters into the stack, but the difference is that the callee of the function cleans up the stack which transfers parameters under this calling convention. Therefore, the epilogue for _stdcal does not perform stack cleanup. In addition, according to the calling convention of _fastcall, the prologue for _fastcall places part of parameters to ECX and EDX registers and pushes the rest of the parameters into the stack from right to left, and the called function performs stack cleanup.

It may be understood that, depending on different programming languages and different called function libraries, a different number of candidate code modules might be needed to comply with different calling conventions. Further, depending on a different calling convention, the execution of each component of the candidate code module is also different. Those skilled in the art can obtain corresponding candidate code modules according to different needs after reading the specification.

Since a number of versions of code modules are pre-obtained in the compiling process to adapt a number of different calling conventions as described hereinabove, it is possible to select an appropriate code module in the process of running the program according to the calling convention actually used by the called function to execute the calling process. To this end, in block 22, a specific calling convention used by the called function in the above program is obtained.

In one embodiment, obtaining the above-mentioned specific calling convention includes determining the specific calling convention by querying load information of the called function in runtime. More specifically, according to one embodiment, the above-mentioned specific calling convention may be determined by analyzing a decorated name of the called function in load information. It may be understood that, when the program is run, a system loader is not only to load compiled code of the program, but also to load the function library called in the program, for example, DLL (Dynamic Link Library). On the other hand, when compiling the program, the compiler may change the symbol name of the function according to certain rules, and this is also known as Name Mangling or Name Decoration. Usually, the rules used by compilers to do name mangling for a function are related to the calling convention of the function. For example, many C program compilers will comply with the following rules: for _stdcall calling convention, adding one underscore prefix before an output function name, adding one “@” symbol and the number of bytes of its parameter after the function name, resulting in the format of _functionname @ number. For example, under _stdcall calling convention, the decorated name of function (int a, int b) is _function @ 8. For _cdec1 calling convention, only one underscore prefix is added before the output function name, and the format is _functionname. For _fastcall calling convention, one “@” symbol is added before the output function name, and one “@” symbol and the number of bytes of its parameter are added after the function name, the format being @functionname@number. Thus, if the called function library is written by C program, then, when the function library is loaded, an exported function with name decorated according to the above rules may be obtained. Such exported function has a decorated name corresponding to the calling convention. Therefore, it is possible to obtain the calling convention of the called function by analyzing its decorated name.

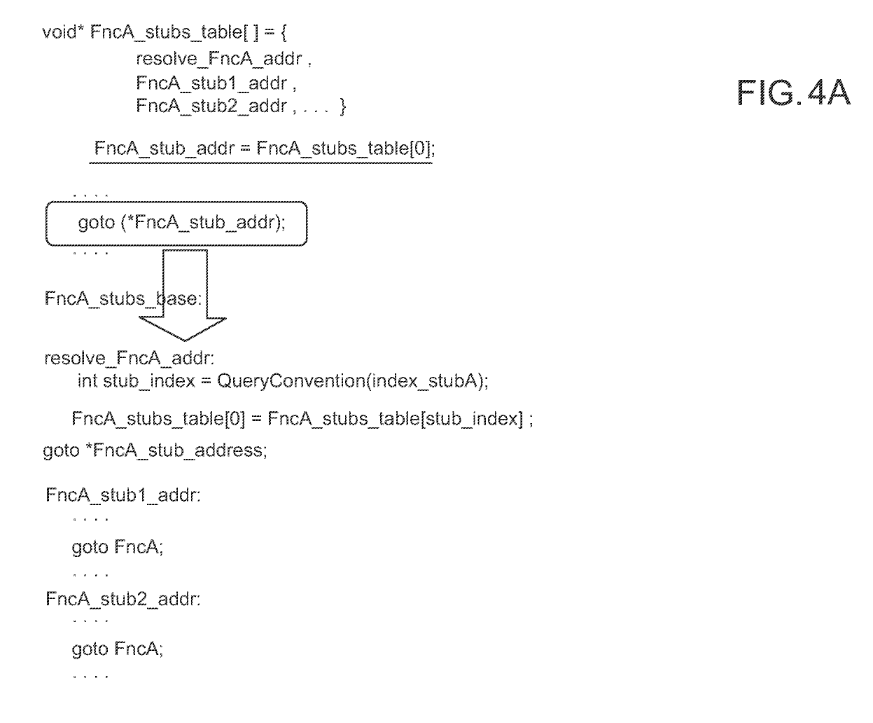

Specifically, FIG. 3 shows sub-procedures for determining the specific calling convention according to an embodiment, i.e. sub-procedure of block 22. As shown in FIG. 3, first in block 221, a query request is sent to the runtime. According to an embodiment, this procedure is implemented by a query statement or query code inserted by the compiler into the compiled program. Specifically, in the program compiling stage, the compiler may insert an appropriate query statement in an appropriate location of the compiled program body for sending a query request to the runtime. The query request may include identification information of the called function to be queried, such as function name and other identification. Next, in block 222, in response to the query request, the decorated name of the called function is obtained. This procedure may be implemented by a system loader in the runtime environment. Specifically, when the program is run, the loader may load the compiled program and the called function library, similar to the prior art. When the query request inserted by the compiler is executed, the loader identifies the called function in response to the query request, and obtains the exported decorated name of the called function from the loaded function library information. Then, in block 223, according to the decorated name, the specific calling convention corresponding to the called function is determined. As mentioned earlier, there is a predetermined correspondence between the decorated name and the calling convention. Therefore, on the basis of obtaining the decorated name of the called function exported from the function library, and referring to the predetermined correspondence, the specific calling convention corresponding to the called function may be determined.

According to one embodiment, in the process of determining the specific calling convention as described above, it is further required to consider the possible name inconsistency problem caused by the name mangling on the function performed by different compilers. For example, assumed that the program written in L1 language calls function FncA in a function library written in L2 language. L1 program compiler, when compiling the program, mangles FncA to name A1 according to the convention of the L1 language, and sends a query request based on A1; while the decorated name of the exported function obtained by the system loader by loading function library information is A2. In such a case, when the above block 222 is executed, it is difficult to locate A2 via A1, that is, it is difficult to obtain the decorated name of the called function FncA. To this end, in one embodiment, the above block 222 is executed in the following way, i.e., first, name demangling is performed on function identification information (e.g., decorated function name) in the query request, so as to obtain the original function name. For example, the original function name FncA may be obtained by demangling A1. Then, the decorated name of the called function in the function library is obtained based on the original function name. In one example, partial match may be performed based on the original function name, to thereby obtain the decorated name. For example, since A2 is a decoration performed on the original function name FncA by certain rule, A2 will generally include the symbol name of FncA, or, A2 and FncA match partially in terms of character. By performing such a partial match, A2 may be found from FncA. Or, in one example, a number of candidate decorations may be performed based on the original function name, until a matched decorated name is obtained. That is, the decoration is tried on the original function name according to a variety of decoration rules, until the decorated function name is consistent with the exported function name in the loaded function library. This process can not only obtain the decorated name of the called function, but also obtain the corresponding decoration rule. Based on the above obtained decoration of the called function, the calling convention with which the called function complies may be determined.

In one embodiment, the specific calling convention adopted by the called function is determined by analyzing other characteristics of the called function in the load information. For example, a part of instructions of the called function may be obtained, and information related to the calling convention, like stack allocation, return address, register setup, etc., is analyzed therefrom. The calling convention adopted by the called function may also be determined via such information.

On the basis of obtaining the specific calling convention adopted by the called function in block 22, in block 23, a code module, which complies with the specific calling convention, may be selected from the candidate code modules provided in block 21, based on the above-mentioned specific calling convention, to execute the function call. In one embodiment, indexes are used to identify different calling conventions, and accordingly, the code modules provided in block 21 are made to be identified by indexes corresponding to their calling conventions. Thus, with the above indexes, a corresponding code module may be selected quickly based on the specific calling convention. Therefore, the function call in the program can be adaptive to a variety of different calling conventions, without the problem of calling convention mismatch.

In one embodiment, in order to increase the execution performance, further improvement is performed on the basis of the foregoing block 22. According to the improvement, after the specific calling convention of the called function is determined by querying loading information, such specific calling convention is recorded, so that it can be obtained directly when the called function is called again. Thus, only when a function is called the first time, it is needed to query the loader for the specific calling convention; when the function is called again, the recorded calling convention may be read directly to select an appropriate code module, so as to perform the calling process more quickly.

In order to implement the above process, in one embodiment, the specific calling convention is recorded by setting a status parameter. Specifically, a status parameter may be set in the compiled program body, and this status parameter has two possible values of 0 and 1, 0 representing the initial call and 1 representing following call. The initial value of this status parameter is set to 0. Each time the function is called, the value of the status parameter is referred to first. If the status parameter is 0, then the aforementioned calling convention query is performed. After the specific calling convention is determined through querying, the calling convention is stored, and the value of the status parameter is modified to 1. When the same function is called thereafter, in response to the value 1 of the status parameter, the previously stored specific calling convention is read directly, thereby simply obtaining the specific calling convention used by the called function.

In one embodiment, the recording of the specific calling convention is implemented through re-direction of address. Specifically, as described above, the code modules provided may be made to be identified via the indexes corresponding to their calling convention. In addition, in order to query load information to determine the specific calling convention, it may be understood that a segment of query code is inserted in the compiled program to perform the query. According to the present embodiment, a pointing address, which is called a first address, for example, is set for the query code. After the query code segment is executed and thus the specific calling convention is determined, the index corresponding to the specific calling convention is recorded, and the address is re-directed, that is, the address (the first address) which originally points to the above query code is modified to a second address, the second address pointing to a candidate code module corresponding to the index of the specific calling convention. Thus, when the function call is executed again, the code module corresponding to the specific calling convention will be executed directly via a redirected address. The execution of the above embodiment is described below in conjunction with a piece of code.

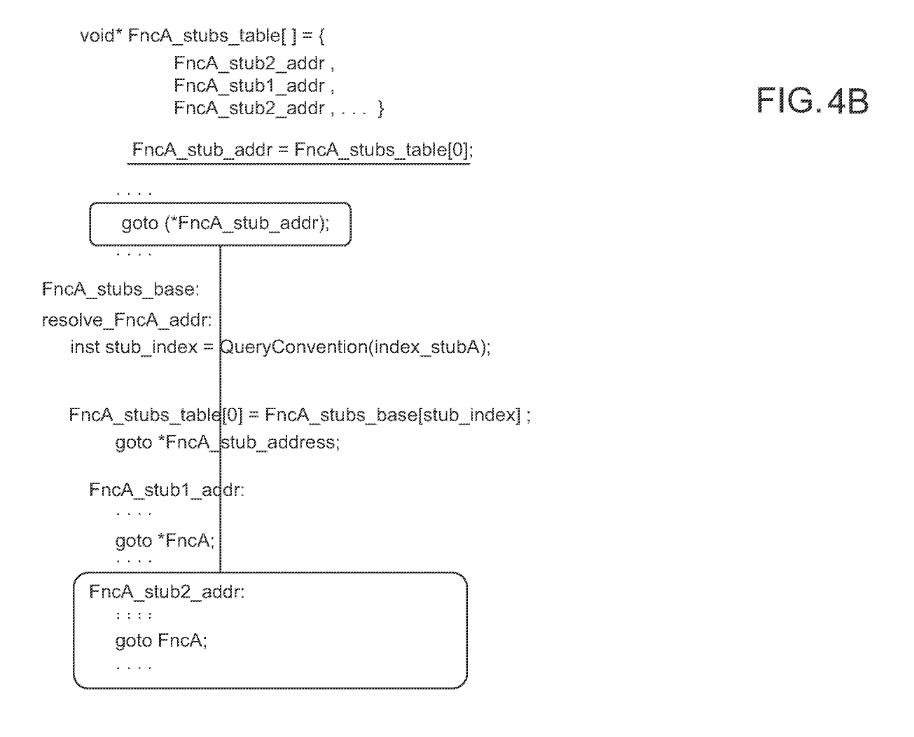

FIGS. 4A-4B show code segment examples according to an embodiment. As shown in FIG. 4A, according to the exemplary code segment, a plurality of addresses are defined in FncA_stubs_table, wherein resolve_FncA_addr points to the query code, FncA_stub1_addr points to a first candidate code module, and FncA_stub2_addr points to a second candidate code module. It may be understood that although not shown here, there may exist more code modules and corresponding point addresses. The code modules correspond to a plurality of calling conventions, and are identified according to the indexes of the calling conventions. The call execution of function FncA starts from go to statement each time, and this statement points to the address identified by underscore FncA_stub_addr=FncA_stubs_table[0]. When the function call is executed at the first time, FncA_stubs_table[0] points to the first address in the FncA_stubs_table, namely, resolve_FncA_addr, while this address points to the query code. Therefore, the execution process proceeds to the query code. As shown, the query code includes a statement for performing calling convention query (QueryConvention). With the returned result of the query code, the calling convention used by function FncA may be determined. The following statement FncA_stubs_table[0]=FncA_stubs_base[stub_index] not only records the index corresponding to the calling convention (stub_index), but also modifies the address which originally points to the query code (address in FncA_stubs_table[0]) to point to a code module corresponding to the specific calling convention. In one example, assuming that the index of the determined calling convention is 2, then, the address in FncA_stubs_table[0] is changed from resolve_FncA_addr to FncA_stub2_addr, as shown in FIG. 4B. Thus, when FncA is called again, the execution still starts from the address FncA_stub_addr=FncA_stubs_table[0]. However, the address in FncA_stubs_table[0] has been changed to FncA_stub2_addr at this time, i.e., pointing to the second candidate code module. Therefore, the execution process will jump directly to the second candidate code module to perform a function call. Thus, by redirecting the address, the process may directly obtain the recorded calling convention, and thus the code module corresponding to that calling convention.

It may be appreciated that the above code is only for illustrating the redirecting process of the address. The actually executed code may use a different language and have a different form.

Furthermore, although it describes hereinabove the specific execution way of recording the determined specific calling convention for use with the function to be called again, the recording way is not limited to the above specific description. With the teachings of the present specification, those skilled in the art may use other ways to implement the above-mentioned recording, so that the recorded calling convention may be directly used for subsequent calling of the same function.

As described above, according to the method of the embodiments of the present invention, there is provided a plurality of versions of code modules for different calling conventions, and a code module of an appropriate version is executed based on the calling convention actually used by the called function. Thus, match of calling convention between the caller and the callee is ensured, avoiding the problem caused by calling convention inconsistency.

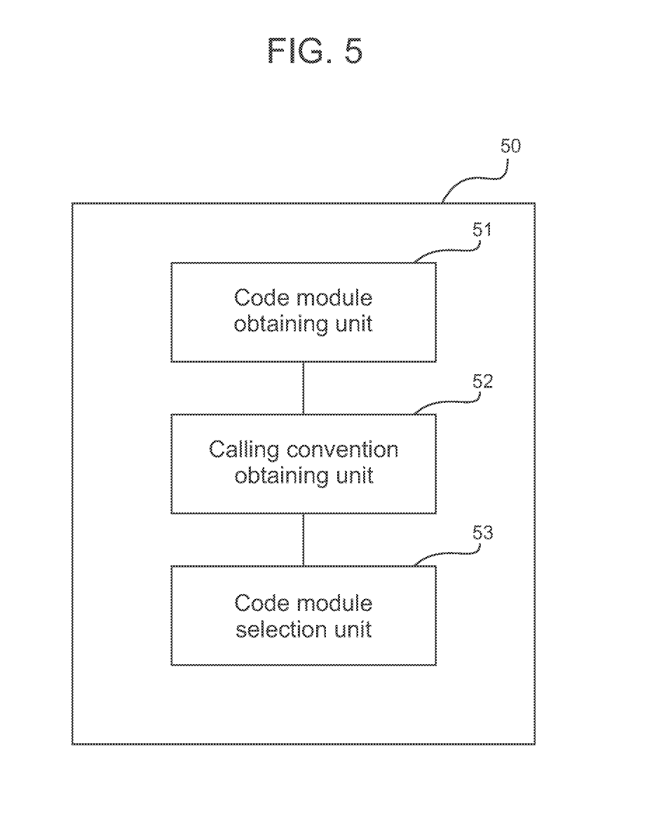

Based on the same inventive concept, an embodiment of the present invention also provides an apparatus for function calling. FIG. 5 shows a block diagram of an apparatus according to the embodiment of the present invention, the apparatus generally being denoted as 50. As shown in FIG. 5, the apparatus for function calling 50 includes: a code module obtaining unit 51 configured to, in response to detection of a function call in a program, obtain a number of candidate code modules for executing the function call, the candidate code modules complying with a number of calling conventions respectively; a calling convention obtaining unit 52 configured to obtain a specific calling convention used by a called function; a code module selection unit 53 configured to, according to the specific calling convention obtained, select from candidate code sections a code module which complies with the specific calling convention to execute the function call.

According to an illustrative embodiment, the code module obtaining unit is configured to, in response to the called function being a function from an external function library, obtain the candidate code modules. At least one of the candidate code modules may include a prologue for performing the preparatory work before the function call; a main body for executing the function call; and an epilogue for doing clean up after the function call. The calling convention obtaining unit may include a calling convention determination sub-unit (not shown), and the sub-unit may be configured to determine the specific calling convention by querying load information of the called function in the program runtime. For example, the calling convention determination sub-unit may be configured to issue a query request to the program runtime, which includes identification information of the called function. In response to the query request, the calling convention determination sub-unit may obtain a decorated name of the called function and determine the specific calling convention corresponding to the called function based on the decorated name.

According to another aspect of the illustrative embodiment, the calling convention determination sub-unit is further configured to perform name demangling based on the identification information of the called function. The calling convention determination sub-unit may obtain an original function name and obtain the decorated name of the called function in the function library based on the original function name. The calling convention obtaining unit may further include a recording sub-unit configured to record the determined specific calling convention in order to directly obtain the specific calling convention when the called function is called again. The recording sub-unit may be configured to record an index corresponding to the specific calling convention, and modify a first address, which points to a code segment for querying the load information, to a second address, which points to a code module corresponding to the index of the specific calling convention among the code modules.

The specific execution ways of the apparatus 50 for function calling may refer to the description of the method of FIG. 2 in conjunction with specific examples, and will not be discussed here in detail. In one embodiment, the code module obtaining unit 51 and the code module selection unit 53 in the apparatus 50 are implemented via a program compiler, and the calling convention obtaining unit 52 is implemented collectively by the compiler and a system loader. In another embodiment, the apparatus 50 may be implemented as an apparatus or tool independent of an existing compiler and/or loader.

The method and apparatus of the embodiments of the present invention can ensure the matching of calling convention between the caller and callee of the function while being transparent to users, so as to avoid problems caused by calling convention inconsistency.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which includes one or more executable instructions for implementing the specified logical function(s). It should also be noted that, in some candidate implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many changes and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for function calling, comprising:
in response to detection of a function call in a program, obtaining a plurality of candidate code modules for executing the function call, the plurality of candidate code modules complying with a plurality of calling conventions respectively;
obtaining a specific calling convention used by a called function;
according to the specific calling convention obtained, selecting from the plurality of candidate code modules a code module which complies with the specific calling convention to execute the function call.

2. The method according to claim 1, wherein obtaining a plurality of candidate code modules comprises, in response to the called function being a function from an external function library, obtaining the plurality of candidate code modules.

3. The method according to claim 1, wherein at least one of the plurality of candidate code modules comprises: a prologue for performing the preparatory work before the function call; a main body for executing the function call; and an epilogue for performing clean up after the function call.

4. The method according to claim 1, wherein obtaining the specific calling convention used by a called function comprises, querying load information of the called function in the program runtime to determine the specific calling convention.

5. The method according to claim 4, wherein querying load information of the called function in the program runtime to determine the specific calling convention comprises:
issuing a query request to the program runtime, which includes identification information of the called function;
in response to the query request, obtaining a decorated name of the called function; and
determining the specific calling convention corresponding to the called function based on the decorated name.

6. The method according to claim 5, wherein obtaining a decorated name of the called function comprises:
performing name demangling based on the identification information of the called function to obtain an original function name; and
obtaining the decorated name of the called function in the function library based on the original function name.

7. The method according to claim 4, wherein obtaining the specific calling convention further comprises recording the determined specific calling convention, in order to directly obtain the specific calling convention when the called function is called again.

8. The method according to claim 7, wherein recording the determined specific calling convention comprises: recording an index corresponding to the specific calling convention, and modifying a first address, which points to a code segment for querying the load information, to a second address, which points to a code module corresponding to the index of the specific calling convention among the plurality of code modules.

9. An apparatus for function calling, comprising:
a code module obtaining unit configured to, in response to detection of a function call in a program, obtain a plurality of candidate code modules for executing the function call, the plurality of candidate code modules complying with a plurality of calling conventions respectively;
a calling convention obtaining unit configured to obtain a specific calling convention used by a called function; and
a code module selection unit configured to, according to the specific calling convention obtained, select from the plurality of candidate code modules a code module which complies with the specific calling convention to execute the function call.

10. The apparatus according to claim 9, wherein the code module obtaining unit is configured to, in response to the called function being a function from an external function library, obtain the plurality of candidate code modules.

11. The apparatus according to claim 9, wherein at least one of the plurality of candidate code modules comprises: a prologue for performing the preparatory work before the function call; a main body for executing the function call; and an epilogue for performing clean up after the function call.

12. The apparatus according to claim 9, wherein the calling convention obtaining unit comprises a calling convention determination sub-unit configured to determine the specific calling convention by querying load information of the called function in the program runtime.

13. The apparatus according to claim 12, wherein the calling convention determination sub-unit is configured to:
issue a query request to the program runtime, which includes identification information of the called function;
in response to the query request, obtain a decorated name of the called function; and
determine the specific calling convention corresponding to the called function based on the decorated name.

14. The apparatus according to claim 13, wherein the calling convention determination sub-unit is configured to:
perform name demangling based on the identification information of the called function to obtain an original function name; and
obtain the decorated name of the called function in the function library based on the original function name.

15. The apparatus according to claim 12, wherein the calling convention obtaining unit further comprises a recording sub-unit configured to record the determined specific calling convention, in order to directly obtain the specific calling convention when the called function is called again.

16. The apparatus according to claim 15, wherein the recording sub-unit is configured to record an index corresponding to the specific calling convention, and modify a first address, which points to a code segment for querying the load information, to a second address, which points to code module corresponding to the index of the specific calling convention among the plurality of code modules.

17. A computer program product for calling functions, the computer program product comprising a computer readable storage medium having program code embodied therewith, the program code executable by a computer to perform a method comprising:
in response to detection of a function call in a program, obtaining a plurality of candidate code modules for executing the function call, the plurality of candidate code modules complying with a plurality of calling conventions respectively;
obtaining a specific calling convention used by a called function;
according to the specific calling convention obtained, selecting from the plurality of candidate code modules a code module which complies with the specific calling convention to execute the function call.

18. The computer program product according to claim 17, wherein obtaining a plurality of candidate code modules comprises, in response to the called function being a function from an external function library, obtaining the plurality of candidate code modules.

19. The computer program product according to claim 17, wherein at least one of the plurality of candidate code modules comprises: a prologue for performing the preparatory work before the function call; a main body for executing the function call; and an epilogue for performing clean up after the function call.

20. The computer program product according to claim 17, wherein obtaining the specific calling convention used by a called function comprises, querying load information of the called function in the program runtime to determine the specific calling convention.
